(19) United States
(12) Patent Application Publication
(10) Pub. No.: US 2008/0126593 A1
(43) Pub. Date: May 29, 2008

(54) Expansion module for a USB port and a method thereof

(76) Inventors: Hsuan-Yi Wang, Zhonghe City (TW); Hsien-Chung Chen, Zhonghe City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/483,622

(22) Filed: Jul. 11, 2006

(51) Int. Cl. G06F 3/00

(52) U.S. Cl. 710/16

(57) ABSTRACT

An expansion module for a USB port of the present invention is applied to a host system device having a program control unit. The expansion module for a USB port includes a plurality of USB interface linking units, a switching unit, and a power switching unit. The USB interface linking units are individually linked with a peripheral device and output a detecting signal to the program control unit. The switching unit switches the peripheral devices according to a first control signal outputted from the program control unit. The power switching unit turns the power on or off as required for the peripheral devices according to a second control signal outputted from the program control unit. Thereby, the switching unit is switched to make the host system device having a single USB port be linked to a plurality of peripheral devices, and the USB port is expanded.

### BACKGROUND OF THE INVENTION

1. Field of the Invention

The present invention relates to an expansion module and a method. In particular, this invention relates to a module and a method that are used for expanding a USB port.

2. Description of the Related Art

Because the hardware of a USB is simple and its format can be easily applied to a variety of devices, such as a storage device, a portable medium playing device, an Internet interface device, I/O devices, and a digital TV receiving device, a lot of devices use a USB as a data accessing interface. The transmission speed of a USB 2.0 meets the requirements of most devices.

Because peripherals having an USB interface have become popular, the number of ports on a USB host (such as a computer, or a multi-media playing device) is inadequate. A USB hub is usually adopted to expand the number of USB ports available. Alternatively, a USB expansion card can be used for expanding the number of USB ports. However, both methods increase the cost of the device. Furthermore, host systems and multi-media playing devices have decreased in size over the years, so it is inconvenient to use an external USB expansion device. If a built-in USB hub is adopted, the cost of the device increases.

### SUMMARY OF THE INVENTION

One particular aspect of the present invention is to provide an expansion module for a USB port and an expanding method thereof. The present invention utilizes a simplified hardware circuit and cooperates with a software program to switch the power and the data bus. It does not use a USB hub chip, and solves the problem of USB peripheral devices that cannot share a single USB port.

The expansion module for a USB port of the present invention is applied to a host system device having a program control unit. The expansion module for the USB port includes a plurality of USB interface linking units, a switching unit, and a power switching unit. The USB interface linking units are individually linked with a peripheral device. After the peripheral device is plugged into the USB interface linking unit, the USB interface linking unit outputs a detecting signal to the program control unit. The switching unit is electrically connected between the USB interface linking unit and the host system device. The switching unit switches and selects the peripheral devices according to a first control signal outputted from the program control unit. The power switching unit turns on or off the power as required for the peripheral devices according to a second control signal outputted from the program control unit.

The operating method of an expansion module for a USB port of the present invention is applied to a host system device. Firstly, whether at least one peripheral device is linked to the host system device is determined. If a peripheral device is linked to the host system device, whether a high priority USB interface linking unit is linked with one of the peripheral devices is determined. If the high priority USB interface linking unit is linked with one of the peripheral devices, the data bus of a switching unit is controlled and provided to the high priority USB interface linking unit. Next, whether switching the peripheral devices to select one of the peripheral devices is executed is determined. If the result is yes, the data bus of the switching unit is controlled and provided to the USB interface linking unit used by the selected peripheral device.

For further understanding of the invention, reference is made to the following detailed description illustrating the embodiments and examples of the invention. The description is only for illustrating the invention and is not intended to be considered limiting of the scope of the claim.

### BRIEF DESCRIPTION OF THE DRAWINGS

The drawings included herein provide a further understanding of the invention. A brief introduction of the drawings is as follows:

FIG. 1 is a block diagram of the expansion module for a USB port of the preferred embodiment of the present invention;

FIG. 2 is a flow chart of the expansion method for a USB port of the preferred embodiment of the present invention;

FIG. 3 is a block diagram of an application of the present invention; and

FIG. 4 is a flow chart of an application of the present invention.

### DETAILED DESCRIPTION OF THE PREFERRED EMBODIMENTS

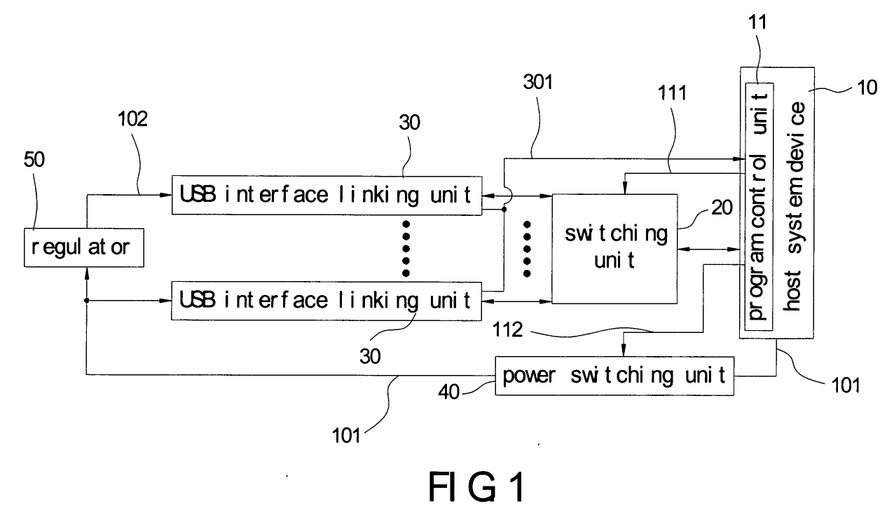

Reference is made to FIG. 1, which shows a block diagram of the expansion module for a USB port of the preferred embodiment of the present invention. The expansion module for a USB port of the present invention is applied to a host system device 10 having a program control unit 11. The expansion module for a USB port includes a switching unit 20, a plurality of USB interface linking units 30, and a power switching unit 40. The USB interface linking units 30 can be USB ports or memory card sockets. The USB interface linking units 30 are individually linked with a peripheral device (not shown in the figure). One of the USB interface linking units 30 is set by the program control unit 11 to be a high priority USB interface linking unit (not shown in the figure).

When a peripheral device is plugged into the USB interface linking unit 30, the USN interface linking unit 30 outputs a detecting signal 301 to the program control unit 11 and the program control unit 11 outputs a first control signal 111 and a second control signal 112 after judging the detecting signal 301. The switching unit 20 electrically connected between the USN interface linking unit 30 and the host system device 10 switches and selects the peripheral devices according to the first control signal 11 outputted from the program control unit 11. The power switching unit 40 turns on or off the power as required for the peripheral devices according to the second control signal 112 outputted from the program control unit 11. The switching unit 20 is a data bus switching element and is used for switching the data signals linked to the peripheral device. The voltage required for the peripheral devices is a first voltage 101 provided from the host system device 10, and the first voltage 101 is transferred into a second voltage 102 via a regulator 50 and the second voltage is provided to other peripheral devices.

The program control unit 11 judges the detecting signal 301 to output the first control signal 111 and the second control signal 112. Alternatively, the program control unit 11 receives a selection coming from an application interface or a remote control to control and output the first control signal 111 and the second control signal 112 so as to switch to the peripheral device selected by the user.

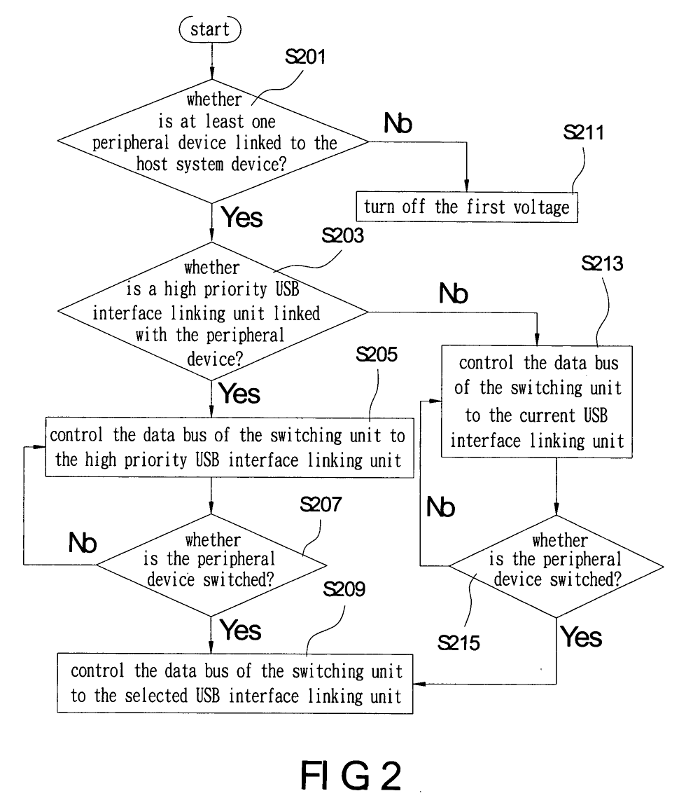

Reference is made to FIG. 2, which shows a flow chart of the expansion module for a USB port of the preferred embodiment of the present invention. The operating method for the expansion module for a USB port of the present invention is applied to a host system device 10. Firstly, whether at least one peripheral device is linked to the host system device is determined (S201). If a peripheral device is linked to the host system device, this means a peripheral device is linked to the USB interface linking unit 30. The host system device 10 provides a first voltage 101 and the program control unit 11 of the host system device 10 outputs a second control signal 112 to conduct the power switching unit 40 so that the first voltage 101 is provided to the peripheral devices. The USB interface linking units 30 can be USB ports or memory card sockets. Next, whether a high priority USB interface linking unit 30 is linked with one of the peripheral devices is determined (S203). If the high priority USB interface linking unit is linked with a peripheral device, the program control unit 11 outputs a first control signal 111 to control and switch the data bus of the switching unit to the high priority USB interface linking unit (S205). Therefore, the peripheral device linked with the high priority USB interface linking unit can transmit data with the host system device 10. The switching unit 20 is a data bus switching element and is used for switching the data bus linked to the USB interface linking units 30.

Next, whether a selection coming from an application interface or a remote control to switch the linked peripheral devices is determined (S207). When the result is yes, the data bus of the switching unit 20 is switched to the USB interface linking unit 30 linked with the peripheral device selected by the user (S209). When the result of step S207 is no, step S205 is executed to keep the data bus of the switching unit 20 on its original status connected to the high priority USB interface linking unit.

When the result of step S201 is no, it means that there is no peripheral device linked with the USB interface linking unit 30. The program control unit 11 outputs the second control signal 112 to turn off the power switching unit 40 to shut down the first voltage 101 provided by the host system device 10 (S211). Power use is thus reduced. When the result of step S203 is no, the data bus of the switching unit 20 is controlled at the USB interface linking device 30 (S213). Next, whether a selection coming from an application interface or a remote control to switch the linked peripheral devices is determined (S215). When the result is yes, step S209 is executed to switch the data bus of the switching unit 20 to the USB interface linking unit 30 linked with the selected peripheral device. When the result of step S215 is no, step S213 is executed to keep the data bus of the switching unit 20 on its original status.

Before the first control signal 111 controls the switching unit 20 to switch the data bus, the second control signal 112 turns off the power switching unit 40 to shut down the first voltage 101 until the switching unit has switched the data bus. Then, the second control signal 112 turns on the power switching unit 40 to conduct the first voltage 101.

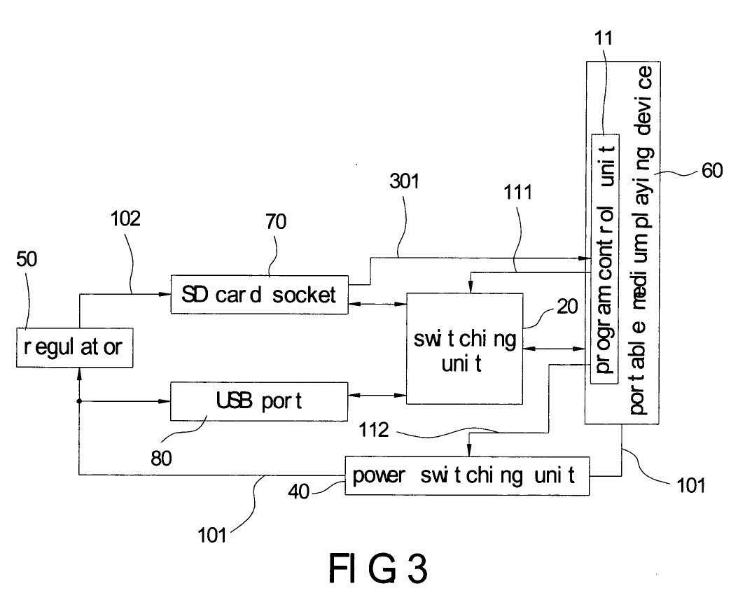

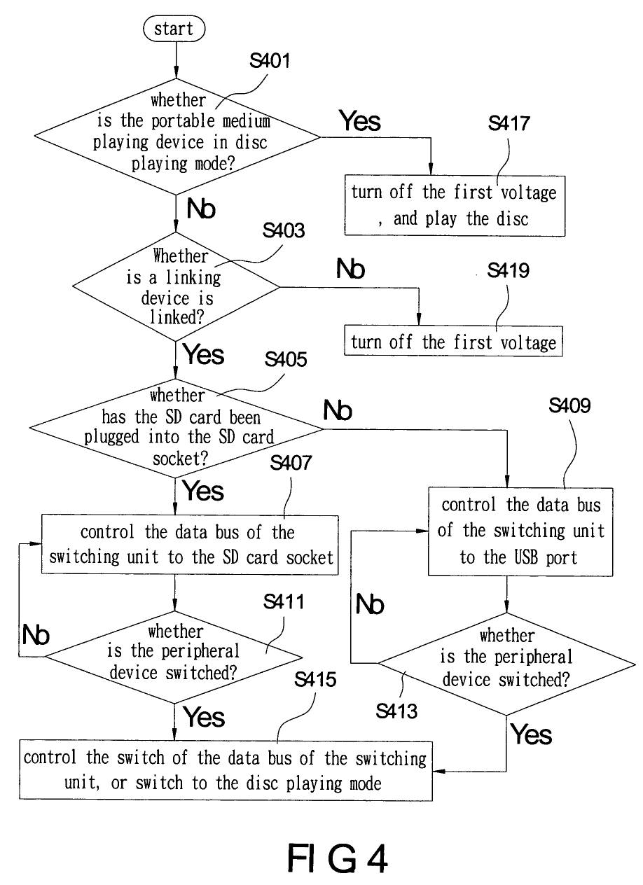

Reference is made to FIGS. 3 and 4, which show a block diagram and a flow chart of an application of the present invention. It is applied to a portable medium playing device 60. Firstly, whether the portable medium playing device is in disc playing mode via a program control unit 11 is determined (S401). It the result is yes, the detecting signal 301 is used to determine whether the SD card socket 70 is linked with an SD card or the USB port 80 is linked with a USB device (S403). In this embodiment, the SD card socket 70 has a high priority. Therefore, when the result of step S403 is yes, whether the SD card has been plugged into the SD card socket 70 is determined (S405). If the result of step S405 is yes, the method controls the switching unit 20 via the first control signal 111 outputted from the program control unit 11 to switch the data bus of the switching unit 20 to the SD card socket 70 (S407). If the result of step S405 is no, the data bus of the switching unit 20 is switched to the USB port 80 (S409). After steps S407 and S409 are executed, whether the user wants to operate at different modes or switch between the peripheral devices via an application interface or a remote control is determined (S411 and S413). When the result of steps S411 and S413 is yes, the method switches the data bus of the switching unit 20 to the SD card socket 70 or the USB port 80, or directly switches the operating mode to the disk playing mode (S415).

Before the first control signal 111 controls the switching unit 20 to switch the data bus, the program control unit turns off the power switching unit 40 via the second control signal 112 to shut down the first voltage 101 until the switching unit has switched the data bus. Then, the second control signal 112 turns on the power switching unit 40 to conduct the first voltage 101. Then, the first voltage 101 is converted into a second voltage 102 via the regulator 50 and the second voltage 102 is provided to the SD card.

When the result of step S401 is yes, the second control signal 112 turns off the power switching unit 40 to shut down the first voltage 101 and directly plays the disk (S417). When the result of step S403 is no, it means that there is no SD card or USB device plugged into the USB interface linking device 30. The first voltage is shut down to reduce power consumption.

The description above only illustrates specific embodiments and examples of the invention. The invention should therefore cover various modifications and variations made to the herein-described structure and operations of the invention, provided they fall within the scope of the invention as defined in the following appended claims.

What is claimed is:

1. An expansion module for a USB port, applied to a host system device having a program control unit, comprising:
a plurality of USB interface linking units individually linked with a peripheral device and outputting a detecting signal to the program control unit;
a switching unit electrically connected between the USB interface linking units and the host system device to switch and select the peripheral devices according to a first control signal outputted from the program control unit; and
a power switching unit, wherein the power switching unit turns on or off the power as required for the peripheral devices according to a second control signal outputted from the program control unit.

2. The expansion module for the USB port as claimed in claim 1, wherein the program control unit judges the detecting signal to output the first control signal and the second control signal.

3. The expansion module for the USB port as claimed in claim 1, wherein the program control unit receives a selection coming from an application interface or a remote control to control the first control signal and the second control signal.

4. The expansion module for the USB port as claimed in claim 1, wherein the USB interface linking units are USB ports or memory card sockets.

5. The expansion module for the USB port as claimed in claim 1, wherein one of the USB interface linking units is set to a high priority USB interface linking unit.

6. The expansion module for the USB port as claimed in claim 1, wherein the switching unit is a data bus switching element.

7. The expansion module for the USB port as claimed in claim 1, wherein the required voltage for the peripheral devices is a first voltage provided from the host system device.

8. The expansion module for the USB port as claimed in claim 7, wherein the first voltage required for the peripheral devices is converted into a second voltage via a regulator.

9. An expansion method for the USB port, applied to a host system device, the method comprising:
providing a plurality of USB interface linking units to connect with a switching unit;
determining whether the USB interface linking units are linked with at least one peripheral device;
when the USB interface linking units are linked with the peripheral device, the host system device receives a detecting signal generated from the peripheral device;
the host system device outputs a first control signal to the switching unit according to the detecting signal; and
the switching unit switches to one of the USB interface linking units according to the first control signal and transmits data with the host system device.

10. The expansion method for the USB port as claimed in claim 9, wherein the switching unit is connected with the data bus of the USB interface linking unit via a switching process.

11. The expansion method for the USB port as claimed in claim 9, wherein one of the USB interface linking units is set to a high priority USB interface linking unit so that the switching unit firstly switches the high priority USB interface linking unit to transmit data with the host interface linking unit.

12. The expansion method for the USB port as claimed in claim 9, wherein the USB interface linking units are USB ports or memory card sockets.

13. The expansion method for the USB port as claimed in claim 9, further comprising:
the host system device outputs a second control signal to a power switching unit according to the detecting signal, wherein the power switching unit controls the host system device to output a first voltage for the USB interface linking units.

14. The expansion method for a USB port as claimed in claim 13, wherein the power switching unit turns on or turns off the first voltage according to the second control signal.

15. The expansion method for a USB port as claimed in claim 9, further comprising:
the host system device receives a selection coming from an application interface or a remote control to output the first control signal.
